(19) United States
(12) Patent Application Publication
(10) Pub. No.: US 2014/0125595 A1
(43) Pub. Date: May 8, 2014

(54) Multi-directional Controller with A Display Integrated Therein

(71) Applicant: SHANPU CO., LTD., New Taipei City (TW)

(72) Inventor: HUNG-MIN LIAO, New Taipei City (TW)

(73) Assignee: SHANPU CO., LTD., New Taipei City (TW)

(21) Appl. No.: 13/670,445

(22) Filed: Nov. 6, 2012

(51) Int. Cl. G06F 3/02

(52) U.S. Cl. 345/168

(57) ABSTRACT

The present invention provides a multi-directional controller with a display integrated therein comprising a main body, a button actuation module attached to the main body and actuated correspondingly thereto and a display module; wherein the main body is soldered onto the bottom of the substrate and the display module comprises a plurality of copper columns provided on and electrically connected to the substrate. The present invention advantageously provides a multi-directional controller having the integrated display module being mechanically unaffected by user's pressings on any directions of the buttons on the button actuation module. As the present invention integrates a small display module with the multi-directional main body, such as a five-directional controller, the controller of the present invention is capable of displaying functional graphics correspondingly while being configured for easy installation on any other forms of electronic devices to increase the overall product feasibilities and values with greater operation convenience.

### TECHNICAL FIELD OF THE INVENTION

The present invention is related to a multi-directional controller with a display integrated therein, in particular, to a multi-directional controller having a display module integrated therein such that the display module is structurally unaffected by the touch inputs pressed on the controllers in order to enhance the feasibility and value of the product, to facilitate the accessibility of the controller and to reduce the manufacturing cost of the multi-directional controller having the display integrated therein.

### DESCRIPTION OF THE PRIOR ART

The utilization of a controller having a display integrated therein is known, and these controllers have been adapted in various forms of electronics as controlling devices including one, for example, having an LCD display integrated with a mechanical controlling structure to form a controller and the like.

The main function of a controller with a display integrated therein is typically to provide a visual presentation on the screen of the display such that predefined functional graphics or wordings representing the operations performed on the controller, such as control operations in sequence, can be effectively displayed in order to allow users to access the controller with enhanced product usability and values as well as to provide users with a controlling interface with greater intelligence.

As touch screens and touch panels gain their popularity in various applications and as far as the current trend of electronic development is concerned, controllers with display are likely to be replaced due to their structural configurations designed mostly for relatively simple controlling interfaces or for devices requiring a multiple number of screen displays for controlling and integrated with software/hardware. In other words, conventional controllers with displays integrated therein are of a relatively poor usability due to the drawbacks of being inconvenient for manipulation or operation and of relatively high manufacturing costs.

Furthermore, despite the fact that touch screens or panels are known for being exceptionally agile and responsive to the operational controls while being fully integrated with such displays, there are, in fact, a great limitations and drawbacks associated with such touch screen or panel type of controllers, for example: 1. due to their relatively smaller screen on the display, accidental touches on the screen often occurs; 2. operations performed on such screen often provides no physical feedbacks to the user (solutions are known in the market but with higher manufacturing costs); and 3. in terms of the manufacturing, they often require a mass production at a relatively large scale including component purchases, resulting in much higher production costs.

### SUMMARY OF THE INVENTION

In view of the aforementioned drawbacks associated with known arts, after years of research and development, the inventor provides a novel design of a multi-directional controller with a display integrated therein having the displaying functions as well as the physical mechanism of control buttons that is unique to its structural configurations and is of relatively low manufacturing costs.

A primary objective of the present invention is to provide a controller having a multi-directional controller main body, such as a five-direction controller, integrated with a display module that is relatively small in size and such that electronic manufacturers are provided with greater product feasibilities and values to assemble or combine the display module of the present invention with others to increase the overall product value, to facilitate the control operations thereof with greater convenience and to lower the overall manufacturing costs.

To achieve the abovementioned objective, the present invention provides a multi-directional controller with a display integrated therein, comprising a multi-directional controller main body, a button actuation module attached to the multi-directional controller main body and configured to be actuated correspondingly thereto; wherein, in particular, the button actuation module comprises a display module arranged therein, and the display module is further secured onto a substrate. As the display module adapts a unique structural design of utilizing copper columns to suspend and secure on the substrate, the button actuation module is able to generate an angular displacement for actuating the multi-directional controller main body corresponding to an effective press by an user in any one of the directions on the button actuation module while being firmly maintained at a secured physical position. In other words, the present invention provides a unique design of a multi-directional controller having a multi-directional controller main body, such as a five-directional controller, integrated with a relatively small display module such that the controller of the present invention are of advantageous features and improvements of capable of being assembled or combined structurally with other electronic devices with ease to increase the overall product values, to facilitate the control operations thereof with greater convenience and to lower the overall manufacturing costs.

### BRIEF DESCRIPTION OF THE DRAWINGS

FIG. 1 is a perspective view of the preferred embodiment of the present invention;

FIG. 2 is an exploded view of the preferred embodiment of the present invention;

FIG. 3 is a cross sectional view of the preferred embodiment of the present invention;

FIG. 4 is a first illustration showing a state of use during an operation of the preferred embodiment of the present invention;

FIG. 5 is a second illustration showing a state of use during an operation of the preferred embodiment of the present invention; and

FIG. 6 is a third illustration showing a state of use during an operation of the preferred embodiment of the present invention.

### DETAILED DESCRIPTION OF THE PREFERRED EMBODIMENTS

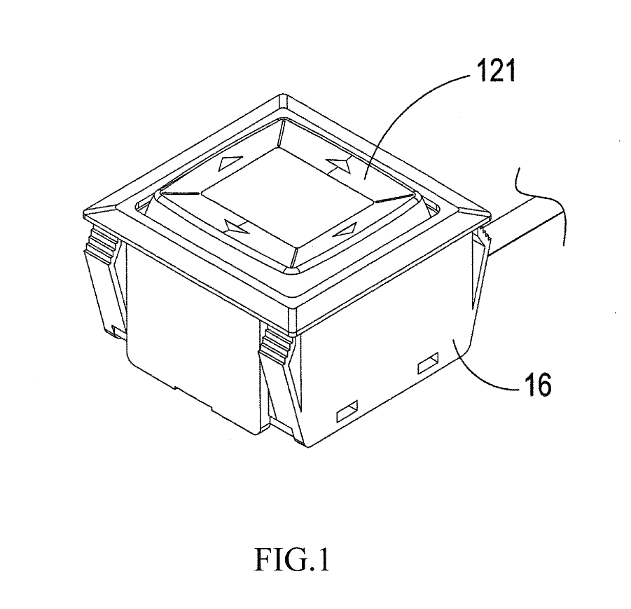

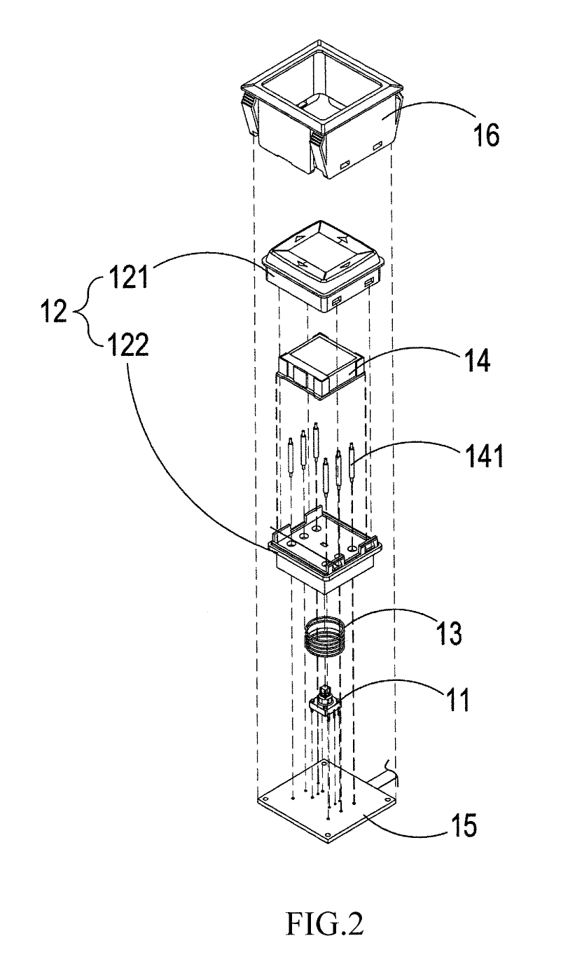

FIGS. 1 and 2 show a perspective view and an exploded view of a preferred embodiment of the present invention respectively. As shown in the figures, a multi-directional controller with a display integrated therein comprises the following unique features.

Accordingly, the present invention provides a multi-directional controller with a display integrated therein comprising: a multi-directional controller main body 11;

a button actuation module 12 attached to said multi-directional controller main body 11 and configured to be actuated correspondingly thereto; at least one elastic member 13 provided between the button actuation module 12 and the multi-directional controller main body 11; and wherein said button actuation module 12 further comprises a directional button 121 for controlling at least one direction and an actuation button 122 integrated with said directional button 121;

a display module 14 provided for displaying an actuation corresponding to said button actuation module 12 and arranged in an internal of said button actuation module 12; and

a substrate 15 attached to said multi-directional controller main body 11 and configured to be actuated correspondingly thereto; and said display module 14 secured onto said substrate 15; and wherein said substrate 15 further comprises an information selection unit attached to said multi-directional controller main body 11 and to said display module 14 and configured to be actuated correspondingly thereto.

Furthermore, in a preferred embodiment of the present invention, the multi-directional controller with a display integrated therein further comprises an outer casing 16 enclosing said multi-directional controller main body 11, said button actuation module 12 and said display module 14.

In addition, in a preferred embodiment of the present invention, said display module 14 can be one of the following displays of: a liquid crystal display (LCD), a thin film transistor liquid crystal display (TFT LCD), an organic light-emitting diode (OLED) and an active matrix OLED (AMOLED).

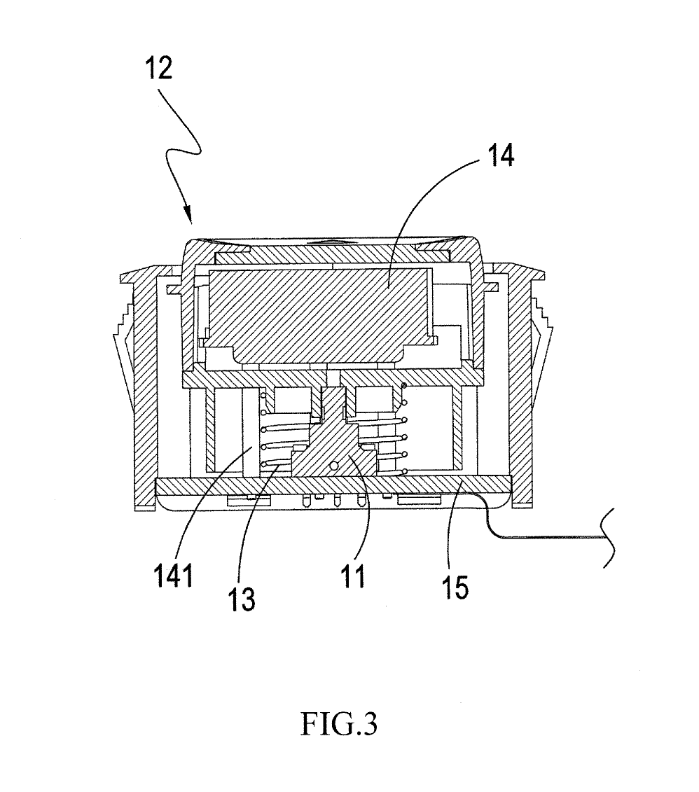

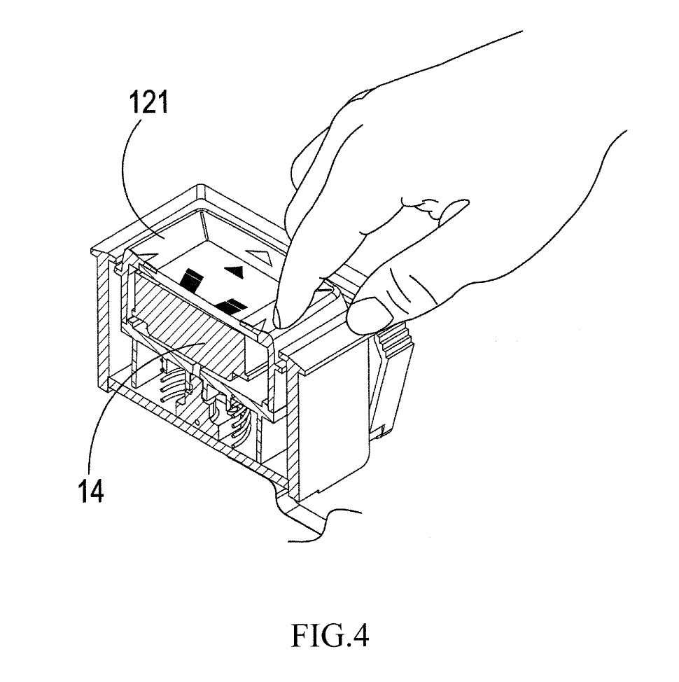

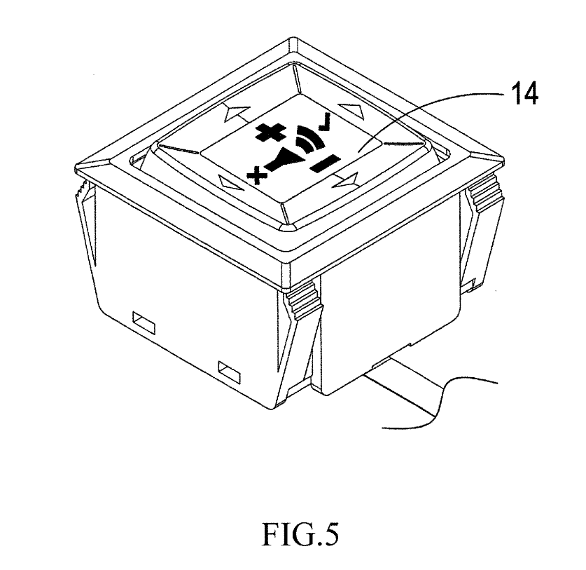

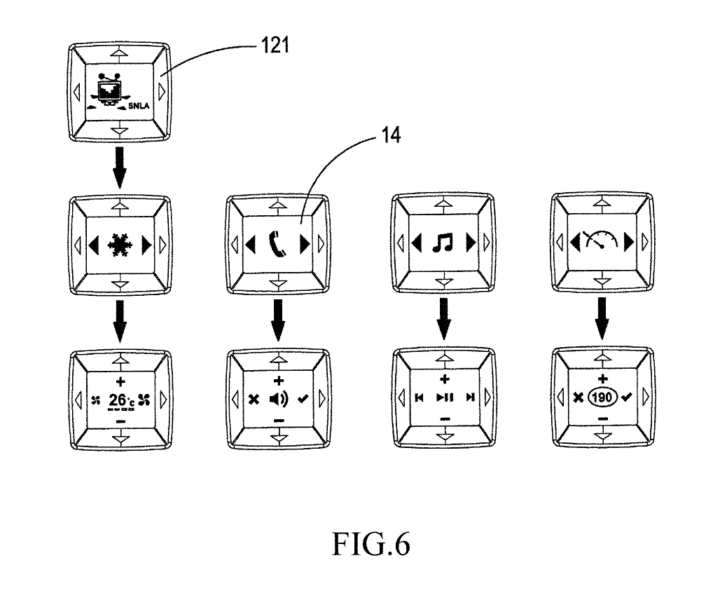

The following is directed to the state of use and operations of the present invention in accordance with the abovementioned structure and configuration design of the present invention and the details thereof as provided below makes references to the accompanied drawings of FIGS. 3-6, in which FIG. 3 is a cross sectional view of a preferred embodiment of the present invention. As shown in the figures, when a user presses on any one of the directions of the directional button 121 of the button actuation module 12, the elastic member 13 is being compressed to actuate the multi-directional controller main body 11 provided on the substrate 15 and a signal is transmitted to the information selection unit by the substrate 15 such that a corresponding representative graphic is shown by the display module 14 to the user for viewing while the display module 14 is properly maintained at a display viewing angle due to the advantageous design of the display module 14 being suspended and secured on the substrate 15 via the copper columns 141 provided thereon. As an illustrative example, the display module 14 of the multi-directional controller with a display integrated therein of the present invention is able to display various types of information and messages; and as shown in FIG. 6, the multi-directional controller can be adapted as fast dialing keys installed on a vehicle steering wheel. Upon the press of any one of the keys by the user, the functional menu is entered and the display module 14 shows a main functional graphic. The user can too press on either the left and right directional buttons 121 on the multi-directional controller to switch between different functions, such as air conditioning, telephone, music or any other fast responsive functions, to access different main functional graphics. In addition, as an illustrative example, the user can press a central portion of the controller for making a confirmation to enter into the aforementioned exemplary main functions and to access further sub-contents or pages and their settings thereof; the user can also access the function of returning to the homepage or first content with a long press on any one of the buttons for a period of, for example, three seconds. In other words, the graphic contents of the functions can be edited or switched via the control program installed or provided on the substrate 15, and the display module 14 utilizes the information on the substrate 15 to shown the contents thereof correspondingly. Furthermore, it can be understood that the aforementioned state of uses and operations of the present invention are provided for illustrative purposes only and that the multi-directional controller with a display integrated therein can be adapted to and installed on any other types of electronic devices such that the drawbacks of operational interface of multi-touches of touch screens or panels can be overcome and such that the overall product value and feasibility of the devices having the controller of the present invention installed thereon can be effectively increased with the merits of having greater control operations with convenience and lower manufacturing costs.

What is claimed is:

1. A multi-directional controller with a display integrated therein, comprising:
a multi-directional controller main body;
a button actuation module attached to said multi-directional controller main body and configured to be actuated correspondingly thereto;
a display module provided for displaying an actuation corresponding to said button actuation module and arranged in an internal of said button actuation module; and
a substrate attached to said multi-directional controller main body and configured to be actuated correspondingly thereto; and said display module secured onto said substrate.

2. The multi-directional controller with a display integrated therein according to claim 1, wherein said substrate further comprises an information selection unit attached to said multi-directional controller main body and to said display module and configured to be actuated correspondingly thereto.

3. The multi-directional controller with a display integrated therein according to claim 1, wherein said display module further comprises a plurality of copper columns secured onto said substrate and electrically connected thereto.

4. The multi-directional controller with a display integrated therein according to claim 1, further comprise at least one elastic member provided between said multi-directional controller main body and said button actuation module.

5. The multi-directional controller with a display integrated therein according to claim 1, wherein said button actuation module further comprises a directional button for controlling at least one direction and an actuation button integrated with said directional button.

6. The multi-directional controller with a display integrated therein according to claim 5, wherein said display module is provided between said directional button and said actuation button.

7. The multi-directional controller with a display integrated therein according to claim 1, further comprises an outer casing enclosing said multi-directional controller main body, said button actuation module and said display module.

8. The multi-directional controller with a display integrated therein according to claim 1, wherein said display module is one of the following displays of a liquid crystal display (LCD), a thin film transistor liquid crystal display (TFT LCD), an organic light-emitting diode (OLED) and an active matrix OLED (AMOLED).
